(19) United States
(12) Patent Application Publication
(10) Pub. No.: US 2025/0242360 A1
(43) Pub. Date: Jul. 31, 2025

(54) SHOWERHEAD ASSEMBLY

(71) Applicant: Clement Inc., FLUSHING, NY (US)

(72) Inventors: CHANGZHENG NI, XIAMEN (CN); CHUNHUA WANG, XIAMEN (CN); YONGQIANG YAN, FUZHOU (CN)

(21) Appl. No.: 18/424,928

(22) Filed: Jan. 29, 2024

(51) Int. Cl. B05B 1/18; B05B 1/16

(52) U.S. Cl. CPC B05B 1/185; B05B 1/1663

(57) ABSTRACT

The present disclosure provides a showerhead assembly. The showerhead assembly comprises a handheld showerhead, a third fixing element, and at least one accessory. The handheld showerhead comprises a first main body and a first fixing element. Wherein the first main body comprises a through hole, the first main body comprises a water outlet surface and a back surface opposite to the water outlet surface, and the through hole penetrating through the water outlet surface and the back surface. The first fixing element and the third fixing element matches with each other to make the third fixing element be installed in the through hole of the first main body, or be removed from the through hole of the first main body easily. The at least one accessory is fixed in the through hole by the third fixing element and protrudes out of the water outlet surface.

### TECHNICAL FIELD

The present disclosure relates to a showerhead assembly.

### BACKGROUND

At present, traditional showerheads only have the function of showering without other auxiliary functions. For example, to massage their body or their head while showering, users must use other functional components in the bathroom.

### SUMMARY OF THE DISCLOSURE

The present disclosure provides a showerhead assembly. In a first aspect, a showerhead assembly comprises: a handheld showerhead comprising a first main body and a first fixing element, wherein the first main body comprises a through hole, the first main body comprises a water outlet surface and a back surface opposite to the water outlet surface, and the through hole penetrating through the water outlet surface and the back surface; a third fixing element, wherein the first fixing element and the third fixing element matches with each other to make the third fixing element be installed in the through hole of the first main body, or be removed from the through hole of the first main body; and at least one accessory fixed in the through hole by the third fixing element and protruding out of the water outlet surface.

In some embodiments, the first fixing element and the third fixing element matches with each other to form a first magnetic attraction structure.

In some embodiments, the at least one accessory is selected from a group of a massager, a comb, a soap dispenser, and a perfume brush.

In some embodiments, the first fixing element is located on a back surface of the first main body or a wall surface of the through hole.

In some embodiments, the third fixing element further comprises a first buckle connecting part protruding out of a surface, and the at least one accessory comprises a second buckle connecting part corresponding to the first buckle connecting part.

In some embodiments, a length of the first buckle connecting part along an axis of the first buckle connecting part is longer than or equal to a length of the through hole along an axis of the through hole.

In some embodiments, a shape of the through hole is round, square, regular shapes or irregular shapes.

In some embodiments, the showerhead assembly further comprises a first assembly comprising a second fixing element corresponding to the first fixing element and a water outlet element, wherein the second fixing element is located on the water outlet element, and the first fixing element and the second fixing element matches with each other to make the handheld showerhead be installed on the water outlet element, or be removed from the water outlet element.

In some embodiments, the water outlet element comprises a water inlet part, and a water outlet part protruding from the water inlet part and a switching component located in the water inlet part, a shape of the water outlet part is corresponding to the shape of the through hole

In some embodiments, the second fixing element is located on a step surface of the water outlet part to form a cyclic structure, and the first fixing element is also a cyclic structure corresponding to the second fixing element and is located on the back surface of the first main body round the through hole.

In some embodiments, the water inlet part comprises a second main body; a water inlet connector connected to a back surface of the second main body; and a water outlet connector connected to a lower end of the second main body.

In some embodiments, the water outlet part comprises a front cover and a water outlet body located in the front cover, the water outlet body is connected to the switching component.

In some embodiments, the switching component comprises a switching element, a fixed base, a water distribution element, and a switching valve, the switching element is movably located in the front cover and connected to the switching valve, the fixed base is located in the second main body, the water inlet connector passes through the second main body, and connects to the fixed base, the water distribution element is located on a surface of the fixed base away from the water inlet connector, the switching valve is located on the water distribution element, and the switching element is connected to the switching valve.

In some embodiments, the switching element is a button, and the button protrudes out of a front surface the front cover.

In some embodiments, the first fixing element and the third fixing element matches with each other to form a second magnetic attraction structure.

In some embodiments, when the water outlet part is inserted into the first main body, the water outlet element and the handheld showerhead is located on a same water outlet surface.

From the above description of the present disclosure, it may be seen that the present disclosure has the following beneficial effects.

First, the showerhead assembly of the present disclosure not only has the function of shower, but also has the function of massaging, combing hair, soap dispensing, or perfume dispensing by fixing the at least one accessory on the handheld showerhead. Therefore, the function of traditional showerheads can be expanded.

Second, the at least one accessory can be fixed on the handheld showerhead by the first fixing element and the third fixing element, to make sure that the at least one accessory can be installed or removed easily.

### BRIEF DESCRIPTION OF THE DRAWINGS

The accompanying drawings described here are intended to provide a further understanding of the present disclosure and form a part of the present disclosure. The schematic embodiments and explanations of the present disclosure are configured to explain the present disclosure and do not constitute an improper limitation of the present disclosure.

FIG. 1 shows a sketch view of a showerhead assembly of one embodiment of the present disclosure.

FIG. 2 shows an exploded view of a showerhead assembly of one embodiment of the present disclosure.

FIG. 3 shows another sketch view of a showerhead assembly of one embodiment of the present disclosure.

FIG. 4 shows a cross-sectional view of a showerhead assembly of one embodiment of the present disclosure.

FIG. 5 shows a front view of a showerhead assembly of one embodiment of the present disclosure.

FIG. 6 shows a side view of a showerhead assembly of one embodiment of the present disclosure.

FIG. 7 shows a front view of a showerhead assembly of another embodiment of the present disclosure.

FIG. 8 shows a side view of a showerhead assembly of another embodiment of the present disclosure.

FIG. 9 shows a front view of a showerhead assembly of the other embodiment of the present disclosure.

FIG. 10 shows a side view of a showerhead assembly of the other embodiment of the present disclosure.

### DETAILED DESCRIPTION

In order to make the technical problems, technical solutions, and beneficial effects to be solved by the present disclosure clearer, the present disclosure may be further explained in detail in conjunction with the accompanying drawings and embodiments. It should be understood that the specific embodiments described here are only intended to explain the present disclosure and are not intended to limit the present disclosure.

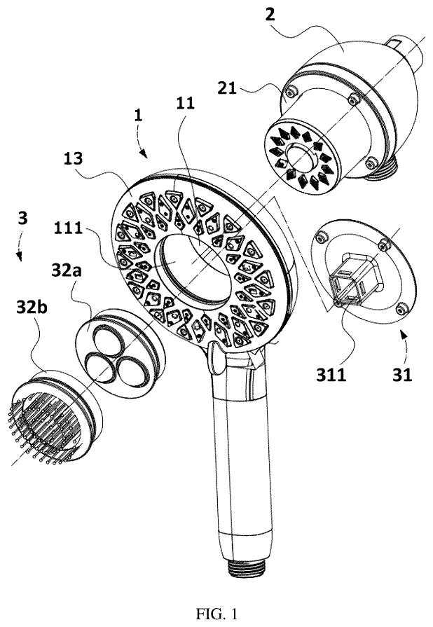

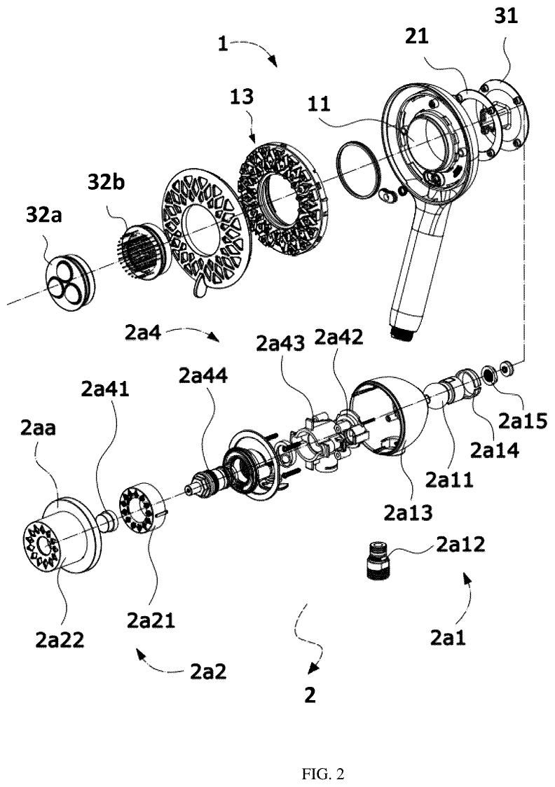

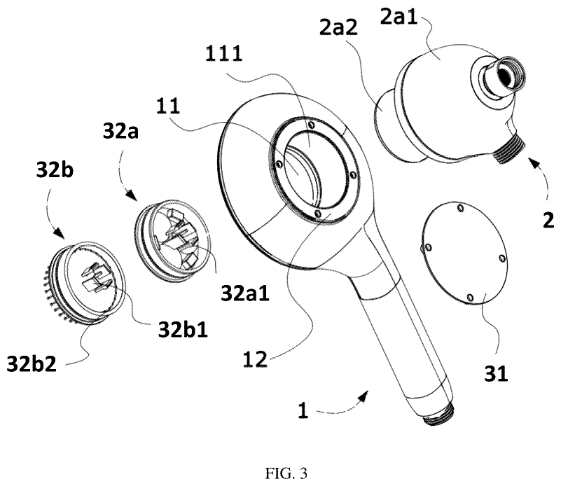

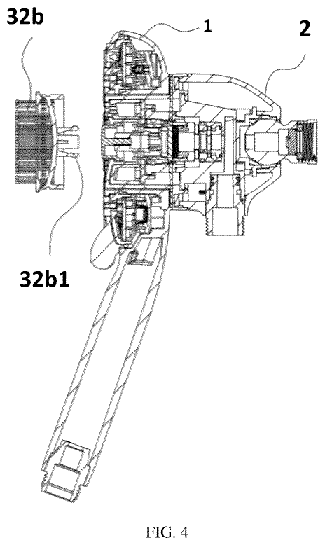

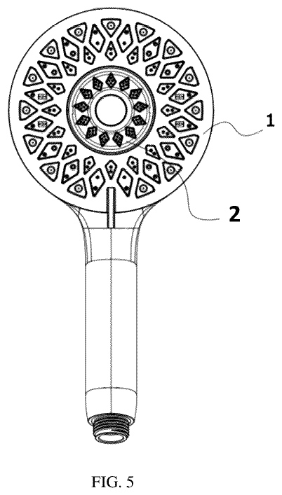

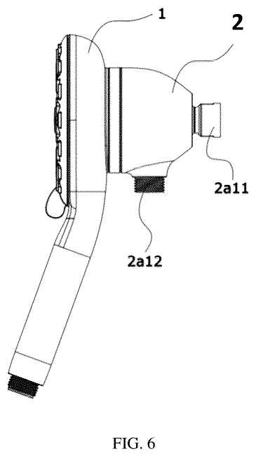

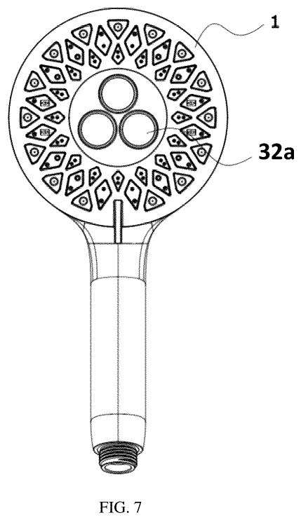

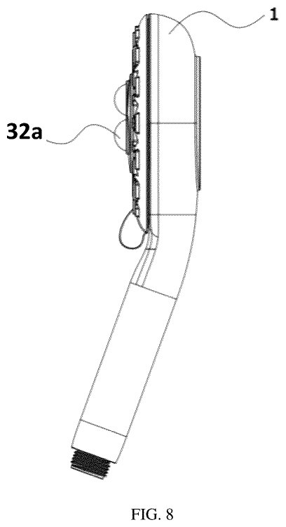

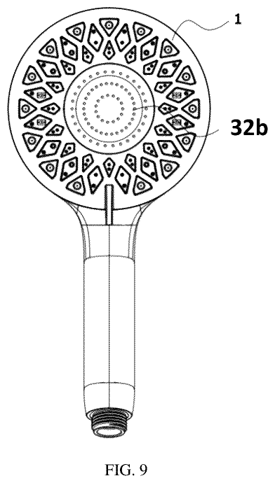

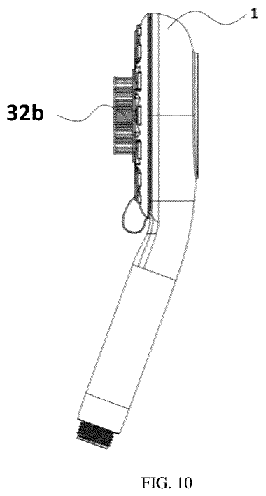

Referring to FIGS. 1 to 11, a showerhead assembly of one embodiment is provided. The showerhead assembly comprises a handheld showerhead 1 and a first assembly 2. When the handheld showerhead 1 is disposed on the first assembly 2, the handheld showerhead 1 and the first assembly 2 can discharge water together. When the handheld showerhead 1 is separated from the first assembly 2, the handheld showerhead 1 and the first assembly 2 can discharge water separately.

The handheld showerhead 1 comprises a first main body 11 comprising a through hole 111, and a first fixing element 12 located on the first main body 11. The first assembly 2 comprises a second fixing element 21 corresponding to the first fixing element 12. Thus, the handheld showerhead 1 can be fixed on the first assembly 2 by the first fixing element 12 and the second fixing element 21 to form an integrated structure. In one embodiment, the first fixing element 12 and the second fixing element 21 are magnetic elements. In other embodiment, the first fixing element 12 is a magnetic element and the second fixing element 21 is an iron element; or the first fixing element 12 is an iron element and the second fixing element 21 is a magnetic element. In other words, the first fixing element 12 and the second fixing element 21 form a first magnetic attraction structure.

The first main body 11 comprises a water outlet surface 13 and a back surface opposite to the water outlet surface 13. The through hole 111 penetrates through the water outlet surface 13 and the back surface. The first fixing element 12 can be located on the back surface of the first main body 11 or a wall surface of the through hole 111. The second fixing element 21 is located at the corresponding position of the first assembly 2.

The through hole 111 can be located on the center of the first main body 11, and a shape of the through hole 111 can be round, square, regular shapes or other irregular shapes. The first assembly 2 comprises a protuberances part having the corresponding shape of the through hole 111.

Referring to FIGS. 1 to 6, in one embodiment, the first assembly 2 comprises a water outlet element. In one embodiment, the water outlet element is a top spray showerhead. The water outlet element comprises a water inlet part 2a1, and a water outlet part 2a2 protruding from the water inlet part 2a1 and a switching component 2a4 located in the water inlet part 2a1. A shape of the water outlet part 2a2 is corresponding to the shape of the through hole 111. The second fixing element 21 can be located on a step surface 2aa of the water outlet part 2a2, to form a cyclic structure. The first fixing element 12 is also a cyclic structure corresponding to the second fixing element 21 and is located on the back surface of the first main body 11 round the through hole 111. Thus, the water outlet part 2a2 can be inserted into the through hole 111 of the first main body 11.

The water inlet part 2a1 comprises a second main body 2a13; a water inlet connector 2a11 connected to a back surface of the second main body 2a13; and a water outlet connector 2a12 connected to a lower end of the second main body 2a13. In one embodiment, the water inlet connector 2a11 is a spherical connector, thus the second main body 2a13 can rotate freely. The water inlet part 2a1 further comprises a snap ring 2a14 and a gasket 2a15 located on one end of the water inlet connector 2a11 away from the water outlet part 2a2 to prevent water leakage. The water outlet part 2a2 comprises a front cover 2a22 and a water outlet body 2a21 located in the front cover 2a22. The water outlet body 2a21 is connected to the switching component 2a4. The switching component 2a4 comprises a switching element 2a41, a fixed base 2a42, a water distribution element 2a43, and a switching valve 2a44. The switching element 2a41 is movably located in the front cover 2a22 and connected to the switching valve 2a44. The fixed base 2a42 is located in the second main body 2a13. The water inlet connector 2a11 passes through the second main body 2a13, and connects to the fixed base 2a42. The snap ring 2a14 locks the water inlet connector 2a11 firmly on the second main body 2a13. The water outlet connector 2a12 passes through the second main body 2a13, and connects to a lower end of the fixed base 2a42. The handheld showerhead 1 connects to the fixed base 2a42 through the water outlet connector 2a12, thus water can pass through the fixed base 2a42 and water outlet connector 2a12 to the handheld showerhead 1. The water distribution element 2a43 is located on a surface of the fixed base 2a42 away from the water inlet connector 2a11. The switching valve 2a44 is located on the water distribution element 2a43. And the switching element 2a41 is connected to the switching valve 2a44. In one embodiment, the switching element 2a41 is a button. The button protrudes out of a front surface the front cover 2a22. And the button can be pressed to control the switching valve 2a44 to switch water flow between the handheld showerhead 1 and the water outlet element.

When the water outlet part 2a2 is inserted into the first main body 11, the water outlet element and the handheld showerhead 1 can be located on a same water outlet surface. And the button is located on the center of the water outlet surface and protrudes out of the water outlet surface. A height of the button protruding out of the water outlet surface ranges from 1 millimeter to about 10 millimeters. In one embodiment, the height of the button protruding out of the water outlet surface is about 5 millimeters. Thus, the button can be easily pressed to switch water flow between the handheld showerhead 1 and the water outlet element. In some embodiment, the switching element 2a41 is a knob. When the handheld showerhead 1 separates from the water outlet element, the handheld showerhead 1 and the water outlet element can discharge water independently.

In one embodiment, the second fixing element 21 is located on outer side wall of the front cover 2a22, and the first fixing element 12 is located on inside wall of the through hole 111 corresponding to the second fixing element 21.

Referring to FIGS. 1 to 3, 7-10, the showerhead assembly of another embodiment further comprises at least one accessory. The at least one accessory can be fixed in the through hole 111 of the first main body 11, when the handheld showerhead 1 separates from the first assembly 2. The at least one accessory can be a massager 32a, a comb 32b, a soap dispenser, or a perfume brush.

The at least one accessory can be fixed in the through hole 111 of the first main body 11 by a third fixing element 31, and protrudes out of the water outlet surface. In one embodiment, the third fixing element 31 further comprises a first buckle connecting part 311 protruding out of a surface. And the at least one accessory comprises a second buckle connecting part corresponding to the first buckle connecting part 311, to make sure that the at least one accessory can be fixed in the through hole 111 of the first main body 11. A length of the first buckle connecting part 311 along an axis of the first buckle connecting part 311 can be longer than or equal to a length of the through hole 111 along an axis of the through hole 111, to make sure that the at least one accessory can be installed or removed easily. In one embodiment, the first fixing element 12 and the third fixing element 31 are magnetic elements. In other embodiment, the first fixing element 12 is a magnetic element and the third fixing element 31 is an iron element; or the first fixing element 12 is an iron element and the third fixing element 31 is a magnetic element. In other words, the first fixing element 12 and the third fixing element 31 form a second magnetic attraction structure.

In one embodiment, the at least one accessory is a massager 32a comprising a second buckle connecting part 32a1, which can be locked by the first buckle connecting part 311. Thus, the massager 32a can be fixed in the through hole 111 of the first main body 11 firmly. A diameter of an elastic ball of the massager 32a ranges from 5 millimeters to 25 millimeters, and a distance between the elastic ball of the massager 32a ranges from 10 millimeters to 20 millimeters. A number of the elastic ball of the massager 32a ranges from 2 numbers to 10 numbers. In one embodiment, the diameter of the elastic ball of the massager 32a is about 15 millimeters.

In another embodiment, the at least one accessory is a comb 32b comprising a second buckle connecting part 32b1, which can be locked by the first buckle connecting part 311. Thus, the comb 32b can be fixed in the through hole 111 of the first main body 11 firmly. The comb 32b can comprises a plurality of elastic bristles. Users of the showerhead assembly can choose different kinds of the at least one accessory according to their needs.

The above exemplary description of the present disclosure is provided in conjunction with the accompanying drawings. It is evident that the specific implementation of the present disclosure is not limited by the aforementioned modes. As long as various non substantial improvements are made using the method concept and technical solutions of the present disclosure, or when the concept and technical solutions of the present disclosure are directly applied to other occasions without improvement, they are all within the scope of protection of the present disclosure.

What is claimed is:

1. A showerhead assembly, comprising:
a handheld showerhead comprising a first main body and a first fixing element, wherein the first main body comprises a through hole, the first main body comprises a water outlet surface and a back surface opposite to the water outlet surface, and the through hole penetrating through the water outlet surface and the back surface;
a third fixing element, wherein the first fixing element and the third fixing element matches with each other to make the third fixing element be installed in the through hole of the first main body, or be removed from the through hole of the first main body; and
at least one accessory fixed in the through hole by the third fixing element and protruding out of the water outlet surface.

2. The water supply shower body according to claim 1, wherein the first fixing element and the third fixing element matches with each other to form a first magnetic attraction structure.

3. The water supply shower body according to claim 1, wherein the at least one accessory is selected from a group of a massager, a comb, a soap dispenser, and a perfume brush.

4. The water supply shower body according to claim 1, wherein the first fixing element is located on a back surface of the first main body or a wall surface of the through hole.

5. The water supply shower body according to claim 1, wherein the third fixing element further comprises a first buckle connecting part protruding out of a surface, and the at least one accessory comprises a second buckle connecting part corresponding to the first buckle connecting part.

6. The water supply shower body according to claim 5, wherein a length of the first buckle connecting part along an axis of the first buckle connecting part is longer than or equal to a length of the through hole along an axis of the through hole.

7. The water supply shower body according to claim 1, wherein a shape of the through hole is round, square, regular shapes or irregular shapes.

8. The water supply shower body according to claim 1, wherein the showerhead assembly further comprises a first assembly comprising a second fixing element corresponding to the first fixing element and a water outlet element, wherein the second fixing element is located on the water outlet element, and the first fixing element and the second fixing element matches with each other to make the handheld showerhead be installed on the water outlet element, or be removed from the water outlet element.

9. The water supply shower body according to claim 8, wherein the water outlet element comprises a water inlet part, and a water outlet part protruding from the water inlet part and a switching component located in the water inlet part, a shape of the water outlet part is corresponding to the shape of the through hole.

10. The water supply shower body according to claim 9, wherein the second fixing element is located on a step surface of the water outlet part to form a cyclic structure, and the first fixing element is also a cyclic structure corresponding to the second fixing element and is located on the back surface of the first main body round the through hole.

11. The water supply shower body according to claim 9, wherein the water inlet part comprises a second main body; a water inlet connector connected to a back surface of the second main body; and
a water outlet connector connected to a lower end of the second main body.

12. The water supply shower body according to claim 11, wherein the water outlet part comprises a front cover and a water outlet body located in the front cover, the water outlet body is connected to the switching component.

13. The water supply shower body according to claim 12, wherein the switching component comprises a switching element, a fixed base, a water distribution element, and a switching valve, the switching element is movably located in the front cover and connected to the switching valve, the fixed base is located in the second main body, the water inlet connector passes through the second main body, and connects to the fixed base, the water distribution element is located on a surface of the fixed base away from the water inlet connector, the switching valve is located on the water distribution element, and the switching element is connected to the switching valve.

14. The water supply shower body according to claim 13, wherein the switching element is a button, and the button protrudes out of a front surface the front cover.

15. The water supply shower body according to claim 8, wherein the first fixing element and the third fixing element matches with each other to form a second magnetic attraction structure.

16. The water supply shower body according to claim 8, wherein when the water outlet part is inserted into the first main body, the water outlet element and the handheld showerhead is located on a same water outlet surface.
